(19) United States
(12) Patent Application Publication
(10) Pub. No.: US 2024/0279409 A1
(43) Pub. Date: Aug. 22, 2024

(54) POLYMER FILM WITH STIMULUS RESPONSIVE AND ANTIBACTERIAL PROPERTIES AND METHOD OF MANUFACTURING THE SAME

(71) Applicant: RESEARCH & BUSINESS FOUNDATION SUNGKYUNKWAN UNIVERSITY, Suwon-si (KR)

(72) Inventors: Jong Hwan SUHR, Suwon-si (KR); Bum Yong YOON, Suwon-si (KR)

(73) Assignee: RESEARCH & BUSINESS FOUNDATION SUNGKYUNKWAN UNIVERSITY, Suwon-si (KR)

(21) Appl. No.: 18/443,497

(22) Filed: Feb. 16, 2024

(30) Foreign Application Priority Data
Feb. 22, 2023 (KR) 10-2023-0023611

(51) Int. Cl. C08J 5/18; A01N 55/00; A01P 1/00; C08L 83/04

(52) U.S. Cl. CPC C08J 5/18; A01N 55/00; A01P 1/00; C08L 83/04; C08J 2383/04; C08J 2497/00; C08L 2203/16

(57) ABSTRACT

One embodiment of the present invention provides a polymer film which has a changed shape according to an external temperature and suppresses the growth of microorganisms on a surface by mixing a depolymerized suberin derivatives extracted from a natural cork with polydimethylsiloxane (PDMS) in order to achieve stimulus responsive and antibacterial properties which are not present in a conventional PDMS material, and the method of manufacturing the same. According to the one embodiment of the present invention, the polymer film can be applied to flexible electronics of which shapes may be changed to fit the characteristics of the human body, human body-attached medical devices for preventing bacterial infections, or the like.

### CROSS REFERENCE TO RELATED APPLICATION

The present application claims priority to Korean Patent Application No. 10-2023-0023611, filed on Feb. 22, 2023, the entire contents of which is incorporated herein for all purposes by this reference.

### BACKGROUND OF THE INVENTION

### Field of the Invention

The present invention relates to a polymer film and a method of manufacturing the same, and more specifically, to a polymer film which may have a changed shape according to an external temperature and suppress the growth of microorganisms on a surface by mixing depolymerized suberin derivatives extracted from a natural cork with polydimethylsiloxane (PDMS) in order to achieve stimulus responsive and antibacterial properties which are not present in a conventional PDMS material.

### Description of the Related Art

Recently, as the convergence of heterogeneous technologies such as a nano-technology, a biotechnology, an information and communication technology, and an energy and environmental technology has accelerated, the research and development for high-performance electronic devices which are bendable and foldable and can be applied to the human body, such as a wearable computer, a realistic display, a human-friendly head-mounted display, an electronic paper, and a flexible display, is progressing rapidly.

In particular, a flexible electronic device is recognized as one of technologies which can lead the electronics industry in line with social and cultural demands for new types of technologies and services which can improve the quality of human life in the future, such as medical, health, safety, energy, and environmental issues. The flexible electronic device is a future-oriented technology and can be regarded as a human-friendly technology which may change and develop a linear technology into a curved technology and a two-dimensional technology into a three-dimensional technology.

Conventional flexible electronic devices may not be deformed by themselves, and shapes thereof are deformed only when an external force is applied, but recently, flexible electronic devices which are self-deformable by coupling an actuator such as a shape memory alloy are being developed. Self-deforming flexible films constituting self-deformable flexible electronic devices are manufactured in the form of coupling a flexible substrate with flexibility to the shape memory alloy, and when the film is bent inward from the substrate through an external force, the shape memory alloy is also bent and at the same time, tensile deformation occurs. The shape memory alloy has the property of being recovered to a recorded shape at a specific temperature even after the occurrence of deformation. In this case, the greater a strain of the shape memory alloy, the greater a restoring force, and thus in order to manufacture excellent self-deformable flexible electronic devices, it is important to manufacture the shape memory alloy in a structure which may be deformed as large as possible.

Generally, commercially available PDMS materials are thermosetting polymers which are synthesized by mixing PDMS oligomers with siloxane bonds (Si—O) with a curing agent and then applying heat or light energy. The PDMS has excellent transparency and flexibility and is inert and non-toxic properties and thus is used as a material for flexible displays and medical devices. However, the PDMS has a disadvantage in the use as a medical device due to a poor property which suppresses the growth of microorganisms on a surface and has a limitation in that it inevitably plays a very passive role when used as a material for an electronic device because it does not have the property which responds to an external stimulus.

### DOCUMENTS OF RELATED ART

(Patent Document 1) Korean Patent No. 10-2042052

### SUMMARY OF THE INVENTION

The present invention is directed to providing a polymer film which shows a stimulus responsive property which remembers and recovers a shape of a polymer film in response to a change in external temperature using crystalline property of depolymerized suberin derivatives and has an antibacterial property which suppresses the growth of microorganisms on a surface by mixing the depolymerized suberin derivatives extracted from a natural cork with polydimethylsiloxane (PDMS), and a method of manufacturing the same.

The objects of the present invention are not limited to the above-described object, and other objects that are not mentioned will be able to be clearly understood by those skilled in the art to which the present invention pertains from the following description.

In order to achieve the object, one embodiment of the present invention provides a polymer film.

A polymer film according to one embodiment of the present invention includes polydimethylsiloxane (PDMS), depolymerized suberin derivatives (DSDs), and a curing agent and has stimulus responsive and antibacterial properties.

In addition, according to the one embodiment of the present invention, a weight ratio of the DSDs to the PDMS may be in a range of 10 to 30 wt %.

In addition, according to the one embodiment of the present invention, a weight ratio of the curing agent to the PDMS may be in a range of 5 to 15 wt %.

In addition, according to the one embodiment of the present invention, the stimulus responsive property may be a shape memory property which responds to a thermal stimulus.

In addition, according to the one embodiment of the present invention, the polymer film may be used in flexible electronics with a shape changed to fit the characteristics of the human body.

In addition, according to the one embodiment of the present invention, the polymer film may be used in human body-attached medical devices for preventing bacterial infections.

In order to achieve the object, another embodiment of the present invention provides a method of manufacturing the polymer film.

The method of manufacturing the polymer film according to one embodiment of the present invention includes uniformly mixing polydimethylsiloxane (PDMS) with depolymerized suberin derivatives (DSDs) and forming a mixture, adding a curing agent to the formed mixture, and processing and curing the mixture to which the curing agent is added in the form of a film.

In addition, according to the one embodiment of the present invention, the forming of the mixture may include mixing the PDMS with the DSDs so that a weight ratio of the DSDs to the PDMS is in a range of 10 to 30 wt %.

In addition, according to the one embodiment of the present invention, the forming of the mixture may be performed in a temperature range of 65 to 100° C.

In addition, according to the one embodiment of the present invention, the forming of the mixture may include melting the DSDs for 20 to 30 minutes, and forming the mixture by mixing the melted DSDs with the PDMS.

In addition, according to the one embodiment of the present invention, the adding of the curing agent may be performed so that the weight ratio of the curing agent to the PDMS is in a range of 5 to 15 wt %.

In addition, according to the one embodiment of the present invention, the processing and curing of the mixture in the form of the film may include spreading the formed mixture in a predetermined thickness, removing bubbles inside the mixture spread in the predetermined thickness, primarily curing the mixture from which the bubbles have been removed, and secondarily curing the mixture subjected to the primary curing operation.

In addition, according to the one embodiment of the present invention, the predetermined thickness may be in a range of 500 to 600 μm.

In addition, according to the one embodiment of the present invention, the primary curing operation may include curing the mixture at a temperature of 80 to 100° C. for 90 to 180 minutes.

In addition, according to the one embodiment of the present invention, the secondary curing operation may include curing the mixture at a temperature of 120 to 160° C. for 50 to 70 minutes.

### BRIEF DESCRIPTION OF THE DRAWINGS

FIG. 1 is a graph illustrating a measurement result of a differential scanning calorimetry (DSC) of depolymerized suberin derivatives (DSDs) extracted from a natural cork.

FIG. 2 illustrates optical microscope photos of a mixture of polydimethylsiloxane (PDMS)/DSDs according to a melting time of the DSDs in a 90° C. convection-type oven.

FIG. 3 illustrates photos after curing reaction when a weight ratio of the PDMS and the DSDs of the mixture of PDMS/DSDs is 9:1, 8:2, and 7:3.

FIG. 4 is a graph illustrating stress-straincurves for each curing condition of neat PDMS and PDMS/DSDs (9:1) samples.

FIG. 5 illustrates the analysis result of an X-ray diffraction (XRD) of the Neat PDMS, DSDs, and PDMS/DSDs samples.

FIG. 6 is a three-dimensional graph illustrating a temperature and load change cycle for measuring a stimulus responsive shape memory property.

FIG. 7 is a flowchart of actual photos capable of demonstrating a shape memory property of the PDMS/DSDS (7:3) sample.

### DETAILED DESCRIPTION OF THE INVENTION

Hereinafter, the present invention will be described with reference to the accompanying drawings. However, the present invention may be implemented in various different forms and is not limited to embodiments described herein. In addition, in order to clearly describe the present invention in the drawings, components irrelevant to the description have been omitted, and throughout the specification, similar components have been denoted by similar reference numerals.

Throughout the specification, when a first component is described as being “connected to (joined to, in contact with, or coupled to)” a second component, this includes not only a case in which the first component is “directly connected” to the second component, but also a case in which the first component is “indirectly connected” to the second component with a third component interposed therebetween. In addition, when the first component is described as “including,” the second component, this means that the first component may further include the third component rather than precluding the third component unless especially stated otherwise.

The terms used in the specification are only used to describe specific embodiments and are not intended to limit the present invention. The singular expression includes the plural expression unless the context clearly dictates otherwise. In the specification, it should be understood that terms such as “comprise” or “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

Hereinafter, embodiments of the present invention will be described in detail with reference to the accompanying drawings.

A polymer film according to one embodiment of the present invention will be described.

An example of the present embodiment, there may be provided a polymer film which includes polydimethylsiloxane (PDMS), depolymerized suberin derivatives (DSDs), and a curing agent and has stimulus responsive and antibacterial properties.

The PDMS is an organosilicon compound, is a representative material which shows viscoelasticity, and behaves like a liquid with high viscosity like honey at high temperatures, but behaves like a solid with elasticity like rubber at low temperatures. The viscoelastic behavior is a characteristic commonly observed in amorphous polymer materials.

When a stress is applied to the PDMS and then removed, a deformed shape does not immediately return to an original state but has an elastic deformation behavior which slowly recovers, which is a phenomenon caused by long chains of a PDMS polymer. In addition, the PDMS is one of silicone oils which are optically transparent and generally have inert, non-toxic and non-flammable properties.

As described above, the PDMS material itself does not have the stimulus responsive and antibacterial properties. In the present invention, it is possible to manufacture a polymer film which can have a changed shape according to an external temperature and suppress the growth of microorganisms on a surface by mixing the DSDs extracted from a natural cork with the PDMS in order to achieve the stimulus responsive and antibacterial properties which are not present in the conventional PDMS material.

The suberin is a substance which is deposited in cell walls of old stems or roots of plants when suberized and corresponds to polymers of various saturated and unsaturated fatty acids. In particular, the reason that the suberized cell walls do not allow water or air to pass therethrough is due to the properties of the suberin. In nature, the suberin makes up a bark of a tree and serves to protect stems and branches and prevent a loss of moisture. The suberin has an insulating function to help the tree withstand a sudden change in external environment. The suberin is also used as a habitat for fungi, lichens, and insects. In the present invention, it is possible to manufacture the polymer film which shows the stimulus responsive property which remembers and recovers the shape of the polymer film according to external temperature changes and has the antibacterial property which suppresses the growth of microorganisms on the surface using the crystalline property of the DSDs.

The stimulus responsive property is generally a property which shows changes in physical/chemical properties as a structure changes reversibly or irreversibly depending on a change in an external environment.

The responsiveness of most stimulus responsive polymers is due to a thermodynamic behavior of a polymer main chain in response to a stimulus. In this case, according to the type of responsive stimulus, the polymer may be classified into heat-responsive, light-responsive, mechanically responsive, and chemically reactive polymers.

In one embodiment of the present invention, there may be a polymer with a heat-responsive type which responds to heat.

As an example of the present embodiment, there may be a polymer film in which a weight ratio of the DSDs to the PDMS is in a range of 10 to 30 wt %.

Depending on the weight ratio of the DSDs, a difference in the properties and performance of the polymer film occurs, and when the weight ratio of the DSDs to the PDMS is in a range of 10 to 30 wt %, the polymer has excellent performance in the stimulus responsive property and preferably has the best stimulus responsive property in a range of 25 to 30 wt %.

In addition, a problem may also occur when the weight ratio of the DSDs is too high. Specifically, during the PDMS curing reaction, a carboxyl group (—COOH) and hydroxy group (—OH) present in the DSDs cause an esterification reaction, and water is generated as a by-product.

In this case, the water generated therein due to the curing of the PDMS remains without evaporation, resulting in a problem of forming voids. Since voids inside the material cause a degradation in the material's mechanical properties and non-uniformity, it is necessary to minimize the formation of voids during manufacturing.

However, in the case of the curing reaction of the mixture of the PDMS and DSDs, there is a problem that more voids are generated as the content of the DSDs increases.

Therefore, in the present invention, by reducing the thickness and at the same time, adjusting curing reaction conditions during the curing of the mixture of the PDMS and DSDs, it is possible to minimize the generation of the voids and show an optimal mechanical property.

As an example of the present embodiment, there may be a polymer film in which a weight ratio of the curing agent to the PDMS is in a range of 5 to 15 wt %.

As an example of the present embodiment, there may be a polymer film in which the stimulus responsive property is a shape memory property which responds to a thermal stimulus.

The shape memory property is a property of a shape memory effect (SME), which is a phenomenon in which a shape is deformed into a completely different shape by applying a force while the shape recorded at a constant temperature is recorded, and then immediately recovered to an original shape upon heating. A material showing the SME is classified into a shape memory alloy (SMA) and a shape memory polymer (SMP).

In the one embodiment of the present invention, the material is the SMP and may have the characteristic of returning to an original shape in response to a thermal stimulus.

As an example of the present embodiment, the polymer film may be used in flexible electronics with a shape changed to fit the characteristics of the human body.

As an example of the present embodiment, the polymer film may be used in human body-attached medical devices for preventing bacterial infections.

In one embodiment of the present invention, the polymer film may be used in substrates of flexible displays and used in a human implantable SMP (suture material or stent) of medical devices.

When the polymer film is used in the substrates of the flexible electronics, unlike conventional technologies, there is an advantage in that the polymer film can play an active role when used in materials for electronic devices because it has the characteristics which respond to an external stimulus.

In addition, when the polymer film is used in medical devices, unlike the conventional technologies, the polymer film has a great advantage when the polymer film is used in medical devices which are inevitably sensitive to bacteria due to the nature of a medical field because it has the characteristics which highly suppress the growth of microorganisms on the surface.

A method of manufacturing a polymer film according to another embodiment of the present invention will be described.

As an example of the present embodiment, there may be provided a method of manufacturing a polymer film including forming a mixture by homogeneously mixing PDMS with DSDS, adding a curing agent to the formed mixture, and processing and curing the mixture to which the curing agent has been added in the form of a film.

As an example of the present embodiment, the forming of the mixture may include mixing the PDMS with the DSDs so that a weight ratio of the DSDs to the PDMS is in a range of 10 to 30 wt %.

Depending on the weight ratio of the DSDs, a difference in the properties and performance of the polymer film occurs, and when the weight ratio of the DSDs to the PDMS is in a range of 10 to 30 wt %, the polymer has excellent performance in the stimulus responsive property and preferably has the best stimulus responsive property in a range of 25 to 30 wt %.

In addition, a problem may also occur when the weight ratio of the DSDs is too high. Specifically, during the PDMS curing reaction, a carboxyl group (—COOH) and hydroxy group (—OH) present in the DSDs cause an esterification reaction, and water is generated as a by-product.

In this case, the water generated therein due to the curing of the PDMS remains without evaporation, resulting in a problem of forming voids. Since voids inside the material cause a degradation in the material's mechanical properties and non-uniformity, it is necessary to minimize the formation of voids during manufacturing.

However, in the case of the curing reaction of the mixture of the PDMS and DSDs, there is a problem that more voids are generated as the content of the DSDs increases.

Therefore, in the present invention, by reducing the thickness and at the same time, adjusting curing reaction conditions during the curing of the mixture of the PDMS and DSDs, it is possible to minimize the generation of the voids and show the optimal mechanical property.

As an example of the present embodiment, the forming of the mixture may be performed in a range of 65 to 100° C.

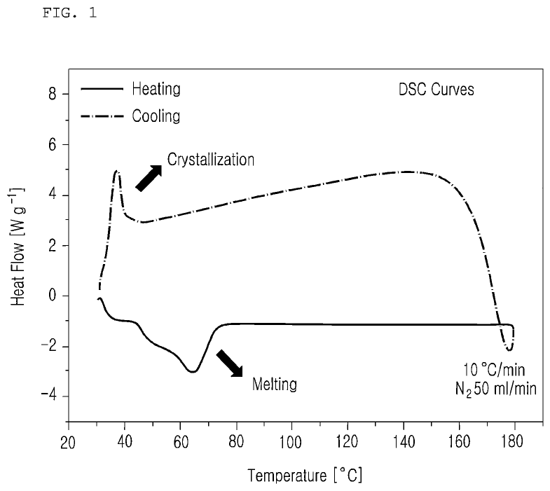

FIG. 1 is a graph illustrating a measurement result of a differential scanning calorimetry (DSC) of depolymerized suberin derivatives extracted from a natural cork.

An example of the present embodiment will be described with reference to FIG. 1.

In the DSC analysis, when the DSDs (sample) is heated from a room temperature to 180° C., an endothermic peak occurs around 65° C., which means that a crystalline phase of the DSDs melts. When the DSDs is re-cooled after heating, an exothermic peak appears at about 40° C., which means that the DSDs are crystallized and generate heat. Through the corresponding analysis, it was experimentally proven that the crystalline property is present in the DSDs.

As described above, the DSDs have a melting temperature of about 65° C. and a crystallization temperature of about 40° C., and an operation of melting the DSDs at a temperature of 65° C. or higher, which is the melting temperature of the DSDs, and then mixing the DSDs with the PDMS may be performed.

As an example of the present embodiment, the forming of the mixture may include melting the DSDs for 20 to 30 minutes and mixing the DSDs with the PDMS and forming a mixture.

In one embodiment of the present invention, the DSDs extracted from the natural cork was added to the PDMS at a predetermined ratio, left in a 90° C. convection-type oven, which was the melting temperature of the DSDS, for a predetermined time to uniformly mix this, and then mixed using a stick.

In this case, the predetermined ratio was a ratio in which the weight ratio of the DSDs to the PDMS was in a range of 10 to 30 wt %.

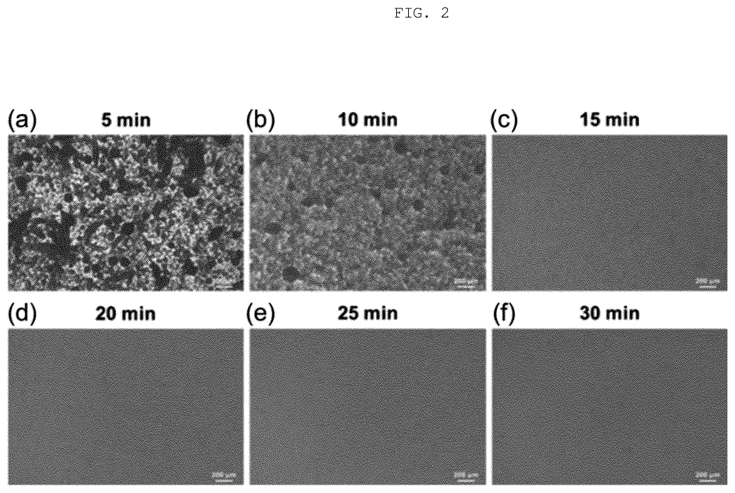

FIG. 2 illustrates optical microscope photos of a mixture of PDMS/DSDs according to a melting time of the DSDs in a 90° C. convection-type oven.

An example of an embodiment of the present invention will be described with reference to FIG. 2.

In an example of the present embodiment, in order to uniformly mix the DSDs with the PDMS, a viscosity should be low, and to this end, an experiment for establishing appropriate temperature and time conditions was conducted.

Referring to FIG. 2, it was found through an optical microscope that the two substances were uniformly mixed after 20 minutes at the temperature of 65° C. or higher, which was the melting temperature of the DSDs (90° C. in this experiment). It can be seen that the dark-colored DSDs are clumped through a photo in which the DSDs and PDMS were heated for 5 minutes and mixed.

As a result, in the melting of the DSDs for 20 to 30 minutes, when the time during which the DSDs are melted is less than 20 minutes, phases of the PDMS and DSDs are divided and not well mixed, resulting in non-uniformity. On the other hand, as in the case of the present invention, the DSDs and PDMS may be mixed uniformly through a melting process for 20 minutes or more.

As an example of the present embodiment, the adding of the curing agent may be performed so that the weight ratio of the curing agent to the PDMS is in a range of 5 to 15 wt %.

As an example of the present embodiment, the processing and curing of the mixture in the form of the film may include spreading the formed mixture in a predetermined thickness, removing bubbles inside the mixture spread in the predetermined thickness, primarily curing the mixture of which bubbles have been removed, and secondarily curing the mixture subjected to the primary curing operation.

As an example of the present embodiment, the predetermined thickness may be in a range of 500 to 600 μm.

While the PDMS curing reaction is performed, carboxyl group (—COOH) and hydroxy group (—OH) present in the DSDs cause an esterification reaction, and water is generated as a by-product.

In this case, the water generated therein due to the curing of the PDMS remains without evaporation, resulting in a problem of forming voids. Since voids inside the material cause a degradation in the material's mechanical properties and non-uniformity, it is necessary to minimize the formation of voids during manufacturing.

However, in the case of the curing reaction of the mixture of the PDMS and DSDs, there is a problem that more voids are generated as the content of the DSDs increases.

Therefore, in one embodiment of the present invention, by forming the mixture in the small thickness of 500 to 600 μm during the curing of the mixture obtained by mixing the PDMS with the DSDs and at the same time, adjusting the curing reaction conditions, it is possible to minimize the generation of bubbles, and by additionally curing the mixture after the removing of the bubbles inside the mixture, it is possible to show the optimal mechanical property.

In one embodiment of the present invention, the removing of the bubbles inside the mixture may be performed in a vacuum.

As an example of the present embodiment, the primary curing operation may include curing the mixture at a temperature of 80 to 100° C. for 90 to 180 minutes.

More preferably, in the primary curing operation, the mixture may be cured at a temperature of 80 to 95° C. for 100 to 140 minutes.

When the carboxyl group (—COOH) and the hydroxy group (—OH) present in the DSDs cause an esterification reaction, water is produced as a by-product of the reaction.

In this case, when a reaction temperature is a boiling point or more of water, bubbles are generated inside the substance, and at the same time, the substance begins to cure, leaving internal voids, which causes a disadvantage that the mechanical property of the substance is degraded.

Therefore, in the one embodiment of the present invention, the temperature range and time are presented so that the curing reaction may occur while minimizing the generation of the bubbles inside the substance.

As an example of the present embodiment, the secondary curing operation may include curing the mixture at a temperature of 120 to 160° C. for 50 to 70 minutes.

More preferably, the secondary curing operation may include curing the mixture at a temperature of 140 to 160° C. for 55 to 65 minutes.

In the primary curing operation before the secondary curing operation, most curable polymers have already undergone the reaction.

The secondary curing operation is an operation for additionally increasing a mechanical strength regardless of the generation of the bubbles.

Since the polymer film manufactured through the embodiment of the present invention shows the stimulus responsive property which records and recovers the shape of the polymer film in response to a change in external temperature and have the antibacterial property which suppresses the growth of microorganisms on the surface, the polymer film can be applied to human body-attached devices, medical devices, or the like by replacing the conventional PDMS without stimulus responsive and antibacterial properties.

TABLE 1
Mixing ratio of PDMS/DSDs (unit: g)

| | 9:1 (DSDS 10 | 8:2 (DSDS 20 | 7:3 (DSDs 30 |
|---|---|---|---|
| | wt %) | wt %) | wt %) |
| PDMS | 8.700 | 8.100 | 7.500 |
| Curing agent | 0.870 | 0.810 | 0.750 |
| DSDS | 0.870 | 1.620 | 2.250 |

Table 1 is a table showing a mixing ratio of a PDMS, a DSDs, and a curing agent.

Manufacturing Examples 1 to 6 below will be described with reference to Table 1.

### Manufacturing Example 1 7:3 PDMS/DSDs (90° C., 2 h & 150° C., 1 h)

A mixture of 7:3 PDMS/DSDs (90° C., 2 h & 150° C., 1 h) was manufactured by setting a mass ratio of the PDMS to DSDs to 7:3, performing the primary curing operation at 90° C. for 2 hours, and performing the secondary curing operation at 150° C. for 1 hour.

The PDMS is measured by using a 70 ml glass vial as shown in Table 1 and put at a ratio of 7:3.

The DSDs are measured by using a plastic measuring cup as shown in Table 1 and put into the vial containing the PDMS at a ratio of 7:3.

The vial containing a mixture of the PDMS and the DSDs is disposed in a convection-type oven preheated to 90° C. to melt the DSDs for 20 minutes.

Then, the vial is taken out from the oven, and the mixture is well mixed by using a stick for 2 minutes.

The mixture of the PDMS and DSDs is cooled to a room temperature, then a curing agent CA is measured as shown in Table 1 and added to the mixture of the PDMS and DSDs, and the mixture is well mixed by using the stick for 1 minutes.

To manufacture PDMS/DSDs film, an acrylic plate with a Teflon tape attached to one surface is first provided to manufacture a PDMS/DSDs film.

The mixture of the PDMS and DSDs is poured onto the Teflon tape and then uniformly spreads using a bar coater in a thickness of 571.5 μm.

After the acrylic plate coated with the PDMS and DSDs is put into a desiccator, internal bubbles are removed in a vacuum for 30 minutes.

The acrylic plate coated with the PDMS and DSDs from which bubbles have been removed is put into the 90° C. convection-type oven, reacted for 2 hours, and then taken out.

Then, after the Teflon tape coated with the PDMS and DSDs has been removed from the acrylic plate, the acrylic plate is put into the convection-type oven preheated to 150° C., reacted for 1 hours, and taken out.

### Manufacturing Example 2 8:2 PDMS/DSDs (90° C., 2 h & 150° C., 1 h)

A mixture of 8:2 PDMS/DSDs (90° C., 2 h & 150° C., 1 h) was manufactured by setting a mass ratio of the PDMS to DSDs to 8:2, performing the primary curing operation at 90° C. for 2 hours, and performing the secondary curing operation at 150° C. for 1 hour.

The PDMS is measured by using a 70 ml glass vial as shown in Table 1 and put at a ratio of 8:2.

The DSDs are measured by using a plastic measuring cup as shown in Table 1 and put into the vial containing the PDMS at a ratio of 8:2.

The vial containing a mixture of the PDMS and the DSDs is disposed in a convection-type oven preheated to 90° C. to melt the DSDs for 20 minutes.

Then, the vial is taken out from the oven, and the mixture is well mixed by using a stick for 2 minutes.

The mixture of the PDMS and DSDs is cooled to a room temperature, then a curing agent CA is measured as shown in Table 1 and added to the mixture of the PDMS and DSDs, and the mixture is well mixed by using the stick for 1 minutes.

To manufacture PDMS/DSDs film, an acrylic plate with a Teflon tape attached to one surface is first provided to manufacture a PDMS/DSDs film.

The mixture of the PDMS and DSDs is poured onto the Teflon tape and then uniformly spreads using a bar coater in a thickness of 571.5 μm.

After the acrylic plate coated with the PDMS and DSDs is put into a desiccator, internal bubbles are removed in a vacuum for 30 minutes.

The acrylic plate coated with the PDMS and DSDs from which bubbles have been removed is put into the 90° C. convection-type oven, reacted for 2 hours, and then taken out.

Then, after the Teflon tape coated with the PDMS and DSDs has been removed from the acrylic plate, the acrylic plate is put into the convection-type oven preheated to 150° C., reacted for 1 hours, and taken out.

### Manufacturing Example 3 9:1 PDMS/DSDs (90° C., 2 h & 150° C., 1 h)

A mixture of 9:1 PDMS/DSDs (90° C., 2 h & 150° C., 1 h) was manufactured by setting a mass ratio of the PDMS to DSDs to 9:1, performing the primary curing operation at 90° C. for 2 hours, and performing the secondary curing operation at 150° C. for 1 hour.

The PDMS is measured by using a 70 ml glass vial as shown in Table 1 and put at a ratio of 9:1.

The DSDs are measured by using a plastic measuring cup as shown in Table 1 and put into the vial containing the PDMS at a ratio of 9:1.

The vial containing a mixture of the PDMS and the DSDs is disposed in a convection-type oven preheated to 90° C. to melt the DSDs for 20 minutes.

Then, the vial is taken out from the oven, and the mixture is well mixed by using a stick for 2 minutes.

The mixture of the PDMS and DSDs is cooled to a room temperature, then a curing agent CA is measured as shown in Table 1 and added to the mixture of the PDMS and DSDs, and the mixture is well mixed by using the stick for 1 minutes.

To manufacture PDMS/DSDs film, an acrylic plate with a Teflon tape attached to one surface is first provided to manufacture a PDMS/DSDs film.

The mixture of the PDMS and DSDs is poured onto the Teflon tape and then uniformly spreads using a bar coater in a thickness of 571.5 μm.

After the acrylic plate coated with the PDMS and DSDs is put into a desiccator, internal bubbles are removed in a vacuum for 30 minutes.

The acrylic plate coated with the PDMS and DSDs from which bubbles have been removed is put into the 90° C. convection-type oven, reacted for 2 hours, and then taken out.

Then, after the Teflon tape coated with the PDMS and DSDs has been removed from the acrylic plate, the acrylic plate is put into the convection-type oven preheated to 150° C., reacted for 1 hours, and taken out.

### Manufacturing Example 4 9:1 PDMS/DSDs (90° C., 2 h & 125° C., 1 h)

A mixture of 9:1 PDMS/DSDs (90° C., 2 h & 125° C., 1 h) was manufactured by setting a mass ratio of the PDMS to DSDs to 9:1, performing the primary curing operation at 90° C. for 2 hours, and performing the secondary curing operation at 125° C. for 1 hour.

In the process of Manufacturing Example 3, the tenth operation is performed in a process in which after the Teflon tape coated with the PDMS and DSDs has been removed from the acrylic plate, the acrylic plate is put into the convection-type oven preheated to 125° C., reacted for 1 hours, and taken out, and the remaining operations are identically performed to manufacture the mixture.

### Manufacturing Example 5 9:1 PDMS/DSDs (90° C., 3 h & 125° C., 1 h)

A mixture of 9:1 PDMS/DSDs (90° C., 3 h & 125° C., 1 h) was manufactured by setting a mass ratio of the PDMS to DSDs to 9:1, performing the primary curing operation at 90° C. for 3 hours, and performing the secondary curing operation at 125° C. for 1 hour.

In the process of Manufacturing Example 3, the ninth operation is performed in a process in which the acrylic plate coated with the PDMS and DSDs from which bubbles have been removed is put into the 90° C. convection-type oven, reacted for 3 hours, and taken out, the tenth operation is performed in a process in which after the Teflon tape coated with the PDMS and DSDs has been removed from the acrylic plate, the acrylic plate is put into the convection-type oven preheated to 125° C., reacted for 1 hours, and taken out, and the remaining operations are identically performed to manufacture the mixture.

### Manufacturing Example 6 9:1 PDMS/DSDs (90° C., 3 h & 150° C., 1 h)

A mixture of 9:1 PDMS/DSDs (90° C., 3 h & 150° C., 1 h) was manufactured by setting a mass ratio of the PDMS to DSDs to 9:1, performing the primary curing operation at 90° C. for 3 hours, and performing the secondary curing operation at 150° C. for 1 hour.

In the process of Manufacturing Example 3, the ninth operation is performed in a process in which the acrylic plate coated with the PDMS and DSDs from which bubbles have been removed is put into the 90° C. convection-type oven, reacted for 3 hours, and taken out, and the remaining operations are identically performed to manufacture the mixture.

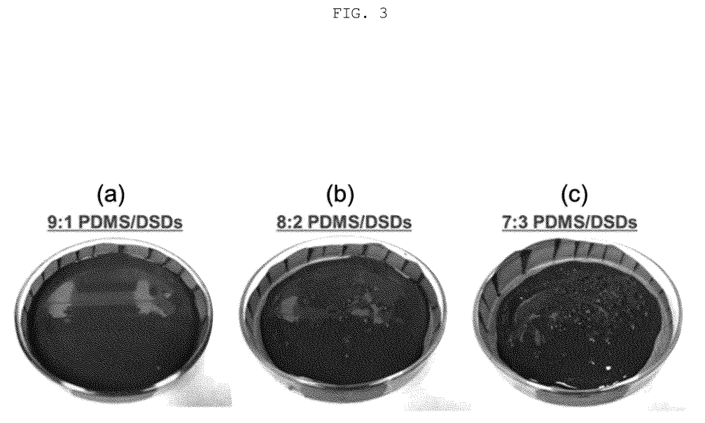

FIG. 3 illustrates photos after curing reaction when a weight ratio of the PDMS and the DSDs of the mixture of PDMS/DSDs is 9:1, 8:2, and 7:3.

Manufacturing Examples 1 to 6 will be additionally described with reference to FIG. 3.

In the above-described manufacturing examples, in the curing the mixture obtained by mixing the DSDs, PDMS, and curing agent by applying heat thereto, as a content of the DSDs increases from 10 to 30 wt %, the carboxyl and hydroxy groups contained in the DSDs cause an esterification reaction, and the generated water evaporates to form voids therein.

In order to prevent this, in the present invention, a condition in which the mixture is reacted at 90° C. for 2 hours and then reacted at 150° C. for 1 hours was derived as the optimal reaction conditions which minimize the generation of bubbles and show the optimal mechanical property by reducing the thickness during the curing of the mixture and at the same time, adjusting the curing reaction conditions.

### Experimental Example 1. Tensile Test of Film for Each Curing Condition

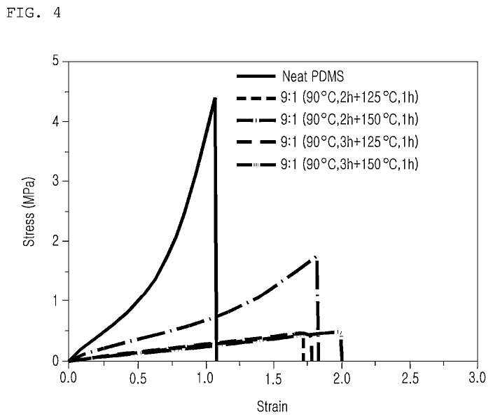

FIG. 4 is a graph illustrating stress-straincurves for each curing condition of neat PDMS and PDMS/DSDs (9:1) samples.

Experimental Example 1 will be described with reference to FIG. 4.

The DSDs were mixed with the cured pure PDMS film at a weight ratio of 9:1, and the tensile test was conducted on the film under different curing reaction conditions.

Referring to FIG. 4, it can be seen that the addition of the DSDs to the PDMS reduces an elastic modulus and tensile strength and increases an elongation after fracture compared to the conventional PDMS. This is because the flexibility of the film increased due to the long hydrocarbon chain of the DSDs. Through the mechanical property results of each film under the different curing reaction conditions illustrated in FIG. 4, it can be seen that a condition with the best elastic modulus and tensile strength is a condition in which the primary curing operation is performed at 90° C. for 2 hours, and then the secondary curing operation is performed at 150° C. for 1 hours.

### Experimental Example 2. X-Ray Diffraction (XRD) Analysis

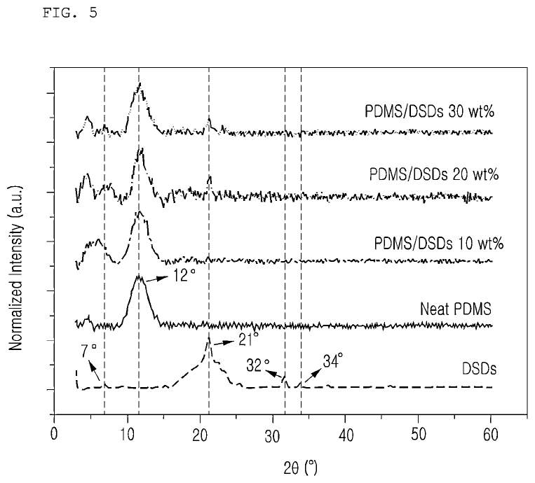

FIG. 5 illustrates the analysis result of an X-ray diffraction (XRD) of the Neat PDMS, DSDs, and PDMS/DSDs samples.

Experimental Example 2 will be described with reference to FIG. 5.

In XRD analysis, characteristic crystalline peaks of the DSDs are 7°, 21°, and 30° to 35°.

Referring to FIG. 5, it can be visually seen that the same result appears in the PDMS/DSDs samples. Through these results, it can be experimentally seen that the crystalline property of the DSDs is possible even after the cured polymer film is formed as in the embodiment of the present invention.

In particular, it can be seen that the peak of 21° among the above-described characteristic crystallization peaks of the DSDs appears more clearly in an XRD graph when the weight ratio of the PDMS to the DSDs of the mixture of the PDMD and DSDs is in a range of 8:2 to 7:3.

Therefore, through the result of FIG. 5, it can be seen that the most preferable weight ratio of the PDMS and DSDs of the mixture of the PDMS and DSDs is in a range of 8:2 to 7:3.

### Experimental Example 3. Dynamic Mechanical Analysis (DMA)

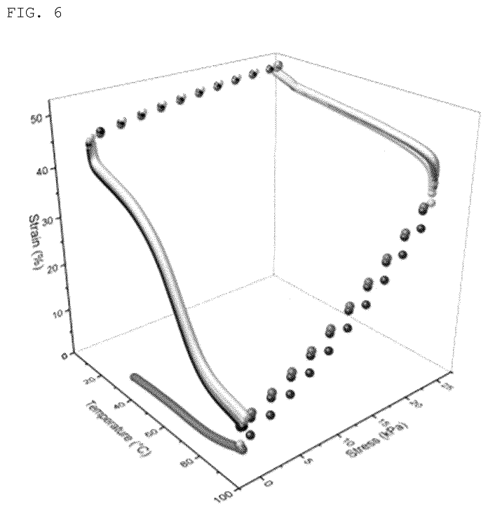

FIG. 6 is a three-dimensional graph illustrating a temperature and load change cycle for measuring a stimulus responsive shape memory property.

Experimental Example 3 will be described with reference to FIG. 6.

The DMA was conducted to check the stimulus responsive shape memory property of the PDMS/DSDs film manufactured in the manufacturing method according to the one embodiment of the present invention. In a process of the DMA, changes in temperature and load were applied to a sample as follows.

The sample was heated from a room temperature to 90° C., and then a load of 24 kPa was applied to the sample while maintaining 90° C. Then, after the temperature is cooled to 10° C., the load is removed and then a strain appearing at this time is checked. This is set to one cycle, and a total of three cycles proceed.

TABLE 2

| | First cycle | | Second cycle | | Third cycle | |
|---|---|---|---|---|---|---|
| | R_{f} (%) | Rᵣ (%) | R_{f} (%) | Rᵣ (%) | R_{f} (%) | Rᵣ (%) |
| 9:1 | 28.3 | 63.7 | 19.2 | 87.4 | 17.4 | 87.0 |
| 8:2 | 74.3 | 90.7 | 71.8 | 97.6 | 71.4 | 97.8 |
| 7:3 | 86.5 | 91.4 | 86.0 | 97.4 | 86.6 | 98.0 |

Table 2 is a table showing a value of a shape fixing ratio (R_{f}) and a value of a shape recovery ratio (Rᵣ) of the PDMS and DSDs film for each content of the DSDs.

In Table 2, R_{f} (N) and Rᵣ (N) indicating the shape memory property value were calculated.

In this case, R_{f} (N)=[(εᵤ(N)−εₚ(N−1))/(E) (N)−εₚ(N−1))]×100(%) is satisfied, Rᵣ (N)=[(εᵤ(N)−εₚ(N))/(εᵤ(N)−εₚ(N−1))]×100(%) is satisfied, N denotes the number of cycles, εᵤ denotes a strain before a load is applied, εₚ denotes an initial strain, and εₗ denotes a strain after the load is applied.

As a result, it can be seen that the 7:3 sample containing the DSDs at 30 wt % has higher R_{f} and Rᵣ than the 9:1 sample containing the DSDs at 10 wt % in all cycles.

In addition, it can be seen that when compared to the 8:2 sample containing the DSDs at 20 wt %, the 7:3 sample has a slightly lower value of Rᵣ in a second cycle, but has the higher remaining values of R_{f} and Rᵣ except for the above value.

Therefore, it can be seen that the 7:3 sample containing the contents of the DSDs at 30 wt % has the best shape memory property.

### Experimental Example 4. Demonstration Experiment on Shape Memory Property

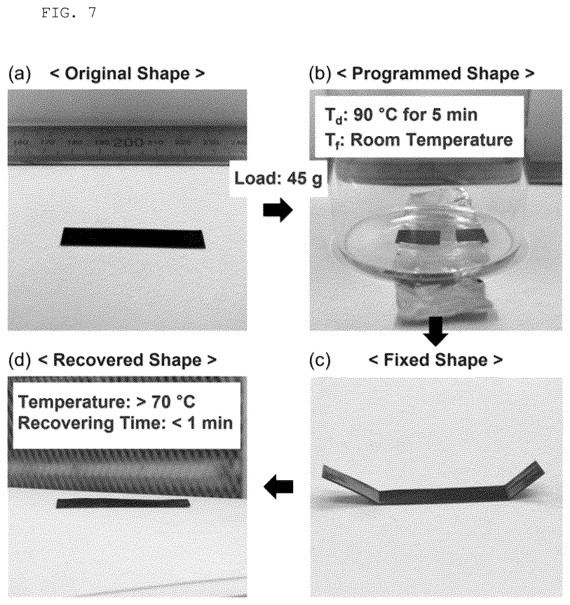

FIG. 7 is a flowchart of actual photos capable of demonstrating a shape memory property of the PDMS/DSDS (7:3) sample.

Experimental Example 4 will be described with reference to FIG. 7.

The following experiment was conducted to check the shape memory property of the PDMS/DSDs (7:3) sample in which the DSDs are added to the PDMS at 30 wt %.

Referring to FIG. 7, both ends of the flat sample were first folded, a weight of 45 g was applied to the sample, the sample was heated at 90° C. for 5 minutes and then was cooled to a room temperature, and the weight was removed.

As illustrated in FIG. 7, it can be seen through actual photos that the sample shows a shape folded from the initial shape, and this is re-recovered to the original flat shape when a temperature of 70° C. or higher is re-applied.

### Experimental Example 5. Antibacterial Property Test on DMS/DSDs (7:3) Sample

TABLE 3

| | Staphylococcus aureus | | Escherichia coli (ATCC | |
|---|---|---|---|---|
| | (ATCC 6538) | | 8739) | |
| | Reference | | Reference | |
| | film | PDMS/ | film | PDMS/ |
| | (sterilized | DSDS | (sterilized | DSDS |
| Sample | PP film) | (7:3) | PP film) | (7:3) |
| Photo | [symbol] | [symbol] | [symbol] | [symbol] |
| Sample | culture medium of 0.4 ml is placed on sample | | | |
| processing | and covered with reference film before 24 hours | | | |
| Concentration | 8.5 × 10⁵ | | 4.5 × 10⁵ | |
| of | | | | |
| inoculum | | | | |
| solution | | | | |
| (CFU/ml) | | | | |
| The number | 1.2 × 10⁶ | <10 | 1.6 × 10⁷ | <10 |
| of bacteria | | | | |
| after 24 | | | | |
| hours | | | | |
| (CFU/ml) | | | | |
| Bacteria | — | 99.9 | — | 99.9 |
| reduction | | | | |
| rate (%) | | | | |

Table 3 is a table showing results of the antibacterial property test of the DMS/DSDs (7:3) sample.

Referring to Table 3, it can be seen that a reference sample (sterilized PP film) has Staphylococcus aureus of which the number of bacteria is 1.2*10⁶ (CFU/ml) after 24 hours and Escherichia coli bacteria of which the number of bacteria is 1.6*10⁷ (CFU/ml) after 24 hours.

On the other hand, it can be seen that in the case of the DMS/DSDs (7:3) sample, both the Staphylococcus aureus and the Escherichia coli bacteria have a very small number of bacterial which is less than 10 (CFU/ml) after 24 hours.

In other words, the DMS/DSDs (7:3) sample shows a very high bacterial reduction rate of 99.9% compared to the reference sample (sterilized PP film). Therefore, it can be seen that the PDMS/DSDs film presented by the present invention can be applied to human body-attached devices, medical devices, or the like in the future by replacing the conventional PDMS without antibacterial property.

According to one embodiment of the present invention, there can be provided the polymer film which can have the changed shape according to the external temperature and suppress the growth of microorganisms on the surface by mixing the depolymerized suberin derivatives extracted from the natural cork with the PDMS in order to achieve stimulus responsive and antibacterial properties which are not present in the conventional PDMS material, and the method of manufacturing the same.

The polymer film can be applied to flexible electronics of which shapes may be changed to fit the characteristics of the human body, human body-attached medical devices for preventing bacterial infections, or the like.

It should be understood that the effects of the present invention are not limited to the above-described effects and include all effects inferrable from the configuration of the invention described in the detailed description or claims of the present invention.

The above description of the present invention is for illustrative purpose, and those skilled in the art to which the present invention pertains will be able to understand that the present invention may be easily modified in other specific forms without changing the technical spirit or essential features thereof. Therefore, it should be understood that the above-described embodiments not are illustrative and restrictive in all respects. For example, each component described in a singular form may be implemented separately, and likewise, components described as being implemented separately may also be implemented in a combined form.

The scope of the present invention is defined by the claims to be described below, and all changes or modifications derived from the meaning and scope of the claims and equivalent concepts thereof should be construed as being included in the scope of the present invention.

What is claimed is:

1. A polymer film comprising
polydimethylsiloxane (PDMS), depolymerized suberin derivatives (DSDs), and a curing agent and having stimulus responsive and antibacterial properties.

2. The polymer film according to claim 1, wherein a weight ratio of the DSDs to the PDMS is in a range of 10 to 30 wt %.

3. The polymer film according to claim 1, wherein a weight ratio of the curing agent to the PDMS is in a range of 5 to 15 wt %.

4. The polymer film according to claim 1, wherein the stimulus responsive property is a shape memory property which responds to a thermal stimulus.

5. A method of manufacturing a polymer film, comprising:
uniformly mixing polydimethylsiloxane (PDMS) with depolymerized suberin derivatives (DSDs) and forming a mixture;
adding a curing agent to the formed mixture; and
processing and curing the mixture to which the curing agent is added in the form of a film.

6. The method according to claim 5, wherein the forming of the mixture includes mixing the PDMS with the DSDs so that a weight ratio of the DSDs to the PDMS is in a range of 10 to 30 wt %.

7. The method according to claim 5, wherein the forming of the mixture is performed in a temperature range of 65 to 100° C.

8. The method according to claim 5, the forming of the mixture includes:
melting the DSDs for 20 to 30 minutes; and
forming the mixture by mixing the melted DSDs with the PDMS.

9. The method according to claim 5, wherein the adding of the curing agent is performed so that a weight ratio of the curing agent to the PDMS is in a range of 5 to 15 wt %.

10. The method according to claim 5, wherein the processing and curing of the mixture in the form of the film includes:
spreading the formed mixture in a predetermined thickness;
removing bubbles inside the mixture spread in the predetermined thickness;
primarily curing the mixture from which the bubbles have been removed; and
secondarily curing the mixture subjected to the primary curing operation.

11. The method according to claim 10, wherein the predetermined thickness is in a range of 500 to 600 μm.

12. The method according to claim 10, wherein the primary curing operation includes curing the mixture at a temperature of 80 to 100° C. for 90 to 180 minutes.

13. The method according to claim 10, wherein the secondary curing operation includes curing the mixture at a temperature of 120 to 160° C. for 50 to 70 minutes.
